(19) United States
(12) Patent Application Publication
(10) Pub. No.: US 2009/0287846 A1
(43) Pub. Date: Nov. 19, 2009

(54) Method and Apparatus for Load Balancing in Network Based Telephony Based On Call Length

(76) Inventors: Arun Kwangil Iyengar, Yorktown Heights, NY (US); Hongbo Jiang, Cleveland, OH (US); Erich Miles Nahum, New York, NY (US); Wolfgang Segmuller, Valhalla, NY (US); Asser Nasreldin Tantawi, Somers, NY (US); Charles P. Wright, Cortlandt Manor, NY (US)

Correspondence Address: RYAN, MASON & LEWIS, LLP, 90 FOREST AVENUE, LOCUST VALLEY, NY, 11560, US

(21) Appl. No.: 12/122,997

(22) Filed: May 19, 2008

(51) Int. Cl. G06F 15/173

(52) U.S. Cl. 709/242; 709/238

(57) ABSTRACT

Techniques are disclosed for load balancing based on call length in networks such as those networks handling telephony applications. By way of example, one method for directing requests associated with calls to servers in a system comprised of a network routing calls between at least one caller and at least one receiver wherein the network comprises a load balancer sending requests to a plurality of servers comprises the following steps. A first request of a call is received. A server s1 is selected to receive the request based on an estimated duration of the call. Another method for directing requests associated with calls to servers in a system comprised of a network routing calls between at least one caller and at least one receiver wherein the network comprises a load balancer sending requests to a plurality of servers comprises the following steps. Information is maintained regarding load assigned to a plurality of servers. A first request of a call is received. A server s1 is selected to receive the request based on the maintained information. The request is sent to server s1. The information regarding load is updated based on an estimated length of the call.

### CROSS REFERENCE TO RELATED APPLICATION

The present application is related to the U.S. patent applications respectively identified by Ser. Nos. 12/110,802 and 12/110,813, both filed on Apr. 28, 2008, the disclosures of which are incorporated by reference herein.

### FIELD OF THE INVENTION

The present invention relates to telephony applications in distributed communication networks and, more particularly, to techniques for load balancing in such applications and networks based on call length.

### BACKGROUND OF THE INVENTION

The Session Initiation Protocol (SIP) is a general-purpose signaling protocol used to control media sessions of all kinds, such as voice, video, instant messaging, and presence. SIP is a protocol of growing importance, with uses in Voice over Internet Protocol (VoIP), Instant Messaging (IM), IP Television (IPTV), Voice Conferencing, and Video Conferencing. Wireless providers are standardizing on SIP as the basis for the IP Multimedia System (IMS) standard for the Third Generation Partnership Project (3GPP). Third-party VoIP providers use SIP (e.g., Vonage), as do digital voice offerings from existing legacy Telcos (e.g., AT&T, Verizon) as well as their cable competitors (e.g., Comcast, Time-Warner).

While individual servers may be able to support hundreds or even thousands of users, large-scale Internet Service Providers (ISPs) need to support customers in the millions. A central component to providing any large-scale service is the ability to scale that service with increasing load and customer demands. A frequent mechanism to scale a service is to use some form of a load-balancing dispatcher that distributes requests across a cluster of servers.

However, almost all research in this space has been in the context of either the Web (e.g., HyperText Transfer Protocol or HTTP) or file service (e.g., Network File Service or NFS). Hence, there is a need for new methods for load balancing techniques which are well suited to SIP and other Internet telephony protocols.

### SUMMARY OF THE INVENTION

Principles of the invention provide techniques for load balancing based on call length in networks such as those networks handling telephony applications.

By way of example, in a first embodiment, a method for directing requests associated with calls to servers in a system comprised of a network routing calls between at least one caller and at least one receiver wherein the network comprises a load balancer sending requests to a plurality of servers comprises the following steps. A first request of a call is received. A server s1 is selected to receive the request based on an estimated duration of the call.

In a second embodiment, a method for directing requests associated with calls to servers in a system comprised of a network routing calls between at least one caller and at least one receiver wherein the network comprises a load balancer sending requests to a plurality of servers comprises the following steps. Information is maintained regarding load assigned to a plurality of servers. A first request of a call is received. A server s1 is selected to receive the request based on the maintained information. The request is sent to server s1. The information regarding load is updated based on an estimated length of the call.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates an example of how the SIP protocol may be used.

FIG. 2 depicts a scalable system for handling calls in accordance with an embodiment of the present invention.

FIG. 3 depicts a scalable system for handling calls in accordance with an embodiment of the present invention.

FIG. 4 depicts a method for load balancing requests to servers based on call length in accordance with an embodiment of the present invention.

FIGS. 5-7 show how session affinity can be maintained using a hash table in accordance with an embodiment of the present invention.

FIG. 8 depicts the use of the TLWL load balancing algorithm in accordance with an embodiment of the present invention.

FIG. 9 shows a computer system in accordance with which one or more components/steps of the techniques of the invention may be implemented.

### DETAILED DESCRIPTION

While illustrative embodiments of the invention are described below in the context of the Session Initiation Protocol (SIP) and the HyperText Transfer Protocol (HTTP), it is to be understood that principles of the invention are not so limited. That is, principles of the invention are applicable to a broad range of protocols which could be used for telephony applications.

SIP is a transaction-based protocol designed to establish and tear down media sessions, frequently referred to as calls. Two types of state exist in SIP. The first, session state, is created by the INVITE transaction and is destroyed by the BYE transaction. Each SIP transaction also creates state that exists for the duration of that transaction. SIP thus has overheads (e.g., central processing unit and/or memory requirements) that are associated both with sessions and transactions, and leveraging this fact can result in more optimized SIP load balancing.

The fact that SIP is session-oriented has important implications for load balancing. Transactions corresponding to the same session should be routed to the same server in order for the system to efficiently access state corresponding to the session. Session-Aware Request Assignment (SARA) is the process by which a system assigns requests to servers in a manner so that sessions are properly recognized by the system and requests corresponding to the same session are assigned to the same server.

Another key aspect of the SIP protocol is that different transaction types, most notably the INVITE and BYE transactions, can incur significantly different overheads; INVITE transactions are about 75 percent more expensive than BYE transactions on certain illustrative systems. The load balancer can make use of this information to make better load balancing decisions which improve both response time and request throughput. In accordance with the invention, we demonstrate how the SARA process can be combined with estimates of relative overhead for different requests to improve load balancing.

The following load balancing algorithms can be used for load balancing in the presence of SIP. They are described in detail in the above-referenced U.S. patent applications respectively identified by Ser. Nos. 12/110,802 and 12/110,813, both filed on Apr. 28, 2008, the disclosures of which are incorporated by reference herein. The algorithms combine the notion of Session-Aware Request Assignment (SARA), dynamic estimates of server load (in terms of occupancy), and knowledge of the SIP protocol. Three such algorithms (with additional algorithms to be further described herein) are generally described as follows:
Call-Join-Shortest-Queue (CJSQ) tracks the number of calls allocated to each back-end node and routes new SIP calls to the node with the least number of active calls.
Transaction-Join-Shortest-Queue (TJSQ) routes a new call to the server that has the fewest active transactions rather than the fewest calls. This algorithm improves on CJSQ by recognizing that calls in SIP are composed of the two transactions, INVITE and BYE, and that by tracking their completion separately, finer-grained estimates of server load can be maintained. This leads to better load balancing, particularly since calls have variable length and thus do not have a unit cost.
Transaction-Least-Work-Left (TLWL) routes a new call to the server that has the least work, where work (i.e., load) is based on estimates of the ratio of transaction costs. TLWL takes advantage of the observation that INVITE transactions are more expensive than BYE transactions. We have found that a 1.75:1 cost ratio between INVITE and BYE results in the best performance. For different systems, this ratio may be different.

We will describe in detail how these algorithms work. We will then show how they can be adapted to take call length into account.

We have implemented these CJSQ, TJSQ, and TLWL in software by adding them to the OpenSER open-source SIP server (http://www.openser.org/) and evaluated them using the SIPp open-source workload generator (http://sipp.sourceforge.net/) driving traffic through the load balancer to a cluster of servers running IBM's WebSphere Application Server (WAS) (http://www-306.ibm.com/software/webservers/appserv/was/). We have run many experiments conducted on a dedicated testbed of Intel x86-based servers connected via Gigabit Ethernet, and these demonstrated that our algorithms offer considerably better performance than any of the existing approaches we tested.

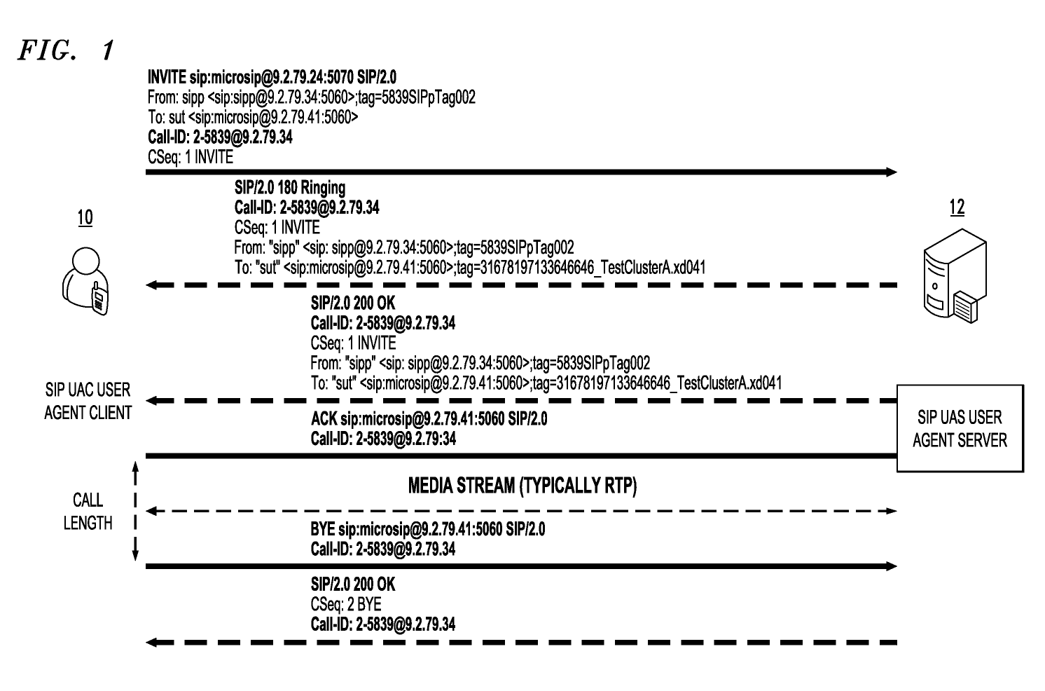

SIP is a control-plane protocol designed to establish, alter, and terminate media sessions between two or more parties. For example, as generally illustrated in FIG. 1, SIP messages are exchanged between a User Agent Client 10 and a User Agent Server 12. The core Internet Engineering Task Force (IETF) SIP specification is given in RFC 3261 (“SIP: Session Initiation Protocol,” Rosenberg et. al, IEFT RFC 3261, the disclosure of which is incorporated by reference herein). Several kinds of sessions can be used, including voice, text, and video, which are transported over a separate data-plane protocol. This separation of the data plane from the control plane is one of the key features of SIP and contributes to its flexibility. SIP was designed with extensibility in mind; for example, the SIP protocol requires that proxies forward and preserve headers that they do not understand.

As other examples, SIP can run over many protocols such as User Datagram Protocol (UDP), Transmission Control Protocol (TCP), Secure Sockets Layer (SSL), Stream Control Transmission Protocol (SCTP), Internet Protocol version 4 (IPv4) and Internet Protocol version 6 (IPv6). SIP does not allocate and manage network bandwidth as does a network resource reservation protocol such as RSVP; that is considered outside the scope of the protocol. SIP is a text-based protocol that derives much of its syntax from HTTP (http://www.w3.org/Protocols/). Messages contain headers and, additionally bodies, depending on the type of message.

For example, in Voice over IP (VoIP), SIP messages contain an additional protocol, the Session Description Protocol (SDP) (“An Offer/Answer Model with the Session Description Protocol (SDP)”, Rosenberg, Schulzrinne, IETF RFC 3264, the disclosure of which is incorporated by reference herein), which negotiates session parameters (e.g., which voice codec to use) between end points using an offer/answer model. Once the end hosts agree to the session characteristics, the Real-time Transport Protocol (RTP) is typically used to carry voice data (“RTP: A Transport Protocol for Real-Time Applications”, Schulzrinne et al, IETF RFC 3550, the disclosure of which is incorporated by reference herein). After session setup, endpoints usually send media packets directly to each other in a peer-to-peer fashion, although this can be complex if network middleboxes such as Network Address Translation (NAT) or firewalls are present.

A SIP Uniform Resource Identifier (URI) uniquely identifies a SIP user, e.g., sip:hongbo@us.ibm.com. This layer of indirection enables features such as location-independence and mobility.

SIP users employ end points known as user agents. These entities initiate and receive sessions. They can be either hardware (e.g., cell phones, pagers, hard VoIP phones) or software (e.g., media mixers, IM clients, soft phones). User agents are further decomposed into User Agent Clients (UAC) and User Agent Servers (UAS), depending on whether they act as a client in a transaction (UAC) or a server (UAS). Most call flows for SIP messages thus display how the UAC and UAS behave for that situation.

SIP uses HTTP-like request/response transactions. A transaction is composed of a request to perform a particular method (e.g., INVITE, BYE, CANCEL, etc.) and at least one response to that request. Responses may be provisional, namely, that they provide some short term feedback to the user (e.g., TRYING, RINGING) to indicate progress, or they can be final (e.g., OK, 407 UNAUTHORIZED). The transaction is completed when a final response is received, but not with only a provisional response.

SIP is composed of four layers, which define how the protocol is conceptually and functionally designed, but not necessarily implemented. The bottom layer is called the syntax/encoding layer, which defines message construction. This layer sits above the IP transport layer, e.g., UDP or TCP. SIP syntax is specified using an augmented Backus-Naur Form grammar (ABNF). The next layer is called the transport layer. This layer determines how a SIP client sends requests and handles responses, and how a server receives requests and sends responses. The third layer is called the transaction layer. This layer matches responses to requests, manages SIP application-layer timeouts, and retransmissions. The fourth layer is called the transaction user (TU) layer, which may be thought of as the application layer in SIP. The TU creates an instance of a client request transaction and passes it to the transaction layer.

A dialog is a relationship in SIP between two user agents that lasts for some time period. Dialogs assist in message sequencing and routing between user agents, and provide context in which to interpret messages. For example, an INVITE message not only creates a transaction (the sequence of messages for completing the INVITE), but also a dialog if the transactions completes successfully. A BYE message creates a new transaction and, when the transaction completes, ends the dialog. In a VoIP example, a dialog is a phone call, which is delineated by the INVITE and BYE transactions.

An example of a SIP message is as follows:

INVITE sip:voicemail@us.ibm.com SIP/2.0
Via: SIP/2.0/UDP sip-proxy.us.ibm.com:5060;branch=z9hG4bK74bf9
Max-Forwards: 70
From: Hongbo <sip:hongbo@us.ibm.com>;tag=9fxced76sl
To: VoiceMail Server <sip:voicemail@us.ibm.com>
Call-ID: 3848276298220188511@hongbo-thinkpad.watson.ibm.com
CSeq: 1 INVITE
Contact: <sip:hongbo@hongbo-thinkpad.watson.ibm.com;transport=udp>
Content-Type: application/sdp
Content-Length: 151
v=0
o=hongbo 2890844526 2890844526 IN IP4
hongbo-thinkpad.watson.ibm.com
s=−
c=IN IP4 9.2.2.101
t=0 0
m=audio 49172 RTP/AVP 0
a=rtpmap:0 PCMU/8000

In this message, the user hongbo@us.ibm.com is contacting the voicemail server to check his voicemail. This message is the initial INVITE request to establish a media session with the voicemail server. An important line to notice is the Call-ID: header, which is a globally unique identifier for the session that is to be created. Subsequent SIP messages must refer to that Call-ID to look up the established session state. If the voicemail server is provided by a cluster, the initial INVITE request will be routed to one back-end node, which will create the session state. Barring some form of distributed shared memory in the cluster, subsequent packets for that session must also be routed to the same back-end node, otherwise the packet will be erroneously rejected. Thus, a SIP load balancer could use the Call-ID in order to route a message to the proper node.

Given the above description of features of SIP, we now present the design and implementation of a load balancer for SIP according to principles of the invention.

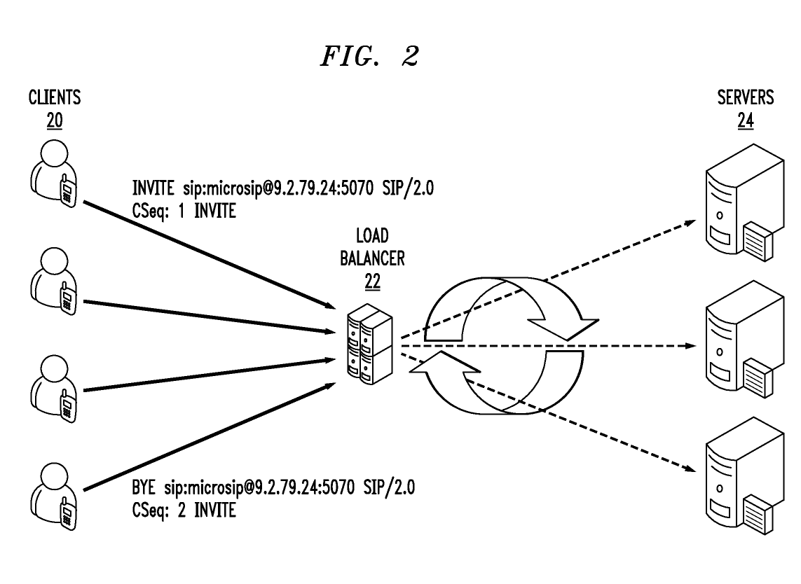

FIG. 2 depicts a scalable system for handling calls in accordance with an embodiment of the present invention. Requests from SIP User Agent Clients 20 are sent to load balancer 22 which then selects a SIP server from among a cluster of servers 24 to handle each request. The various load balancing algorithms presented herein according to principles of the invention use different methods for picking SIP servers to handle requests. Servers send responses to SIP requests (such as 180 TRYING or 200 OK) to the load balancer which then sends each response to the client.

A key aspect of our load balancer is that it implements Session-Aware Request Assignment (SARA) so that requests corresponding to the same session (call) are routed to the same server. The load balancer has the freedom to pick a server to handle the first request of a call. All subsequent requests corresponding to the call go to the same server. This allows all requests corresponding to the same session to efficiently access state corresponding to the session. SARA is important for SIP and is usually not implemented in HTTP load balancers.

An important consideration in picking the node to receive the first request corresponding to a call is the estimated cost of the call itself. Our work has demonstrated that call duration has a significant effect on call overhead.

In our experiments measuring the effect of call duration on call overhead, we set up two test beds. The first test bed includes one machine running SIPp in user-agent client (UAC) mode and another machine running SIPp in user-agent server (UAS) mode. SIPp, a SIP workload generator, is a freely available open-source tool and has an active user community. It allows a wide range of SIP scenarios such as UAC and UAS. The UAC sends an INVITE request to a UAS, which acknowledges the client via 180 RINGING and 200 OK messages. When the dialog is finished after a call ends, the UAC “hangs up” and generates a BYE request to UAS which, in turn, responds with a 200 OK back to the UAC.

When the call length is zero, the client generates a BYE request as soon as the session is established when the client receives a 200 OK reply from the server. When the call length is determined by a statistical distribution (e.g., Gaussian distribution with a mean of 60 seconds and a standard deviation of 30 seconds), it is of interest to find out how performance is affected. We have run experiments lasting for 3 minutes after 3 minutes of warm-up time. When the call length is nonzero and distributed according to a Gaussian distribution, the peak throughput is decreased by about 20%, only 2600 calls/second (cps) compared to 3200 cps with a zero call length in our test.

A second test bed uses IBM's Websphere application server, which has integrated support for SIP, to run in UAS mode. Each experiment lasts for 3 minutes after 10 minutes warm-up time. With a Gaussian distribution for call length, the peak throughput is decreased by about 10%, from 300 cps to 275 cps. With longer call durations, throughput is reduced even further.

Advantageously, principles of the invention use call time duration to make load balancing decisions.

There are a number of ways in which call duration can be predicted. One is by maintaining statistics regarding call durations for callers, receivers, and/or caller-receiver pairs. The system can also correlate call durations based on the time of day. By considering the caller, receiver, and/or time of day associated with a call, the system can make predictions regarding the expected length of the call.

Once the load balancer has an estimate of call duration, it can use this information in a variety of ways:
As our results demonstrate, longer calls consume more resources. The load balancer can make its load balancing decisions based on the estimated resource consumption of requests. Estimated call duration would be an important factor in estimating the resource consumption of a request.
   In the TLWL algorithm, we typically set a relative weight of 1.75 for INVITE requests and 1.0 for BYE requests. Intuitively, a 3-hour call needs more resources than a 3-sec call. It is reasonable to set a higher weight for the longer call than the shorter one.
In some cases, requests could be assigned to servers based on call duration. For example, some servers could be specifically allocated to handle calls expected to be of long duration, while other servers could be allocated to handle calls expected to be of shorter duration.
A load balancer could assign tasks to nodes by considering how long the tasks are likely to take. That way, it estimates when resources are likely to become available. By having call duration estimations, the load balancer makes more informed decisions about assigning calls to nodes.

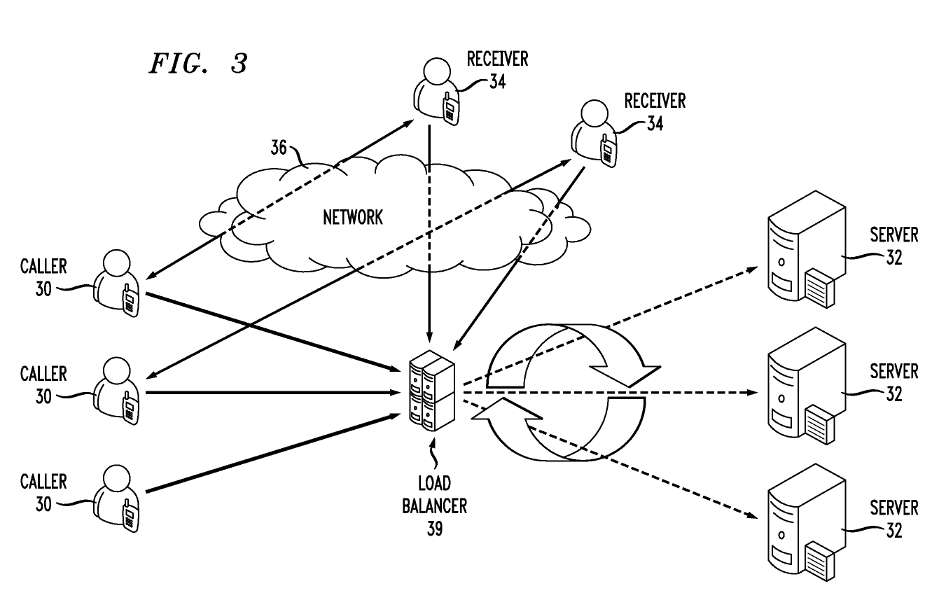

FIG. 3 shows a system in which features according to the invention may be implemented (i.e., one or more of the load balancing algorithms described herein). The figure shows a plurality of callers 30 and receivers 34. A “receiver” refers to an entity or device receiving a call from the “caller” (calling entity or device). If a protocol such as SIP is being used, both callers 30 and receivers 34 can function as clients or user agent clients (UAC). In some cases, such as if SIP is being used as a communication protocol, the load balancer 39 may receive responses from servers 32 which it forwards to callers 30 and/or receivers 34.

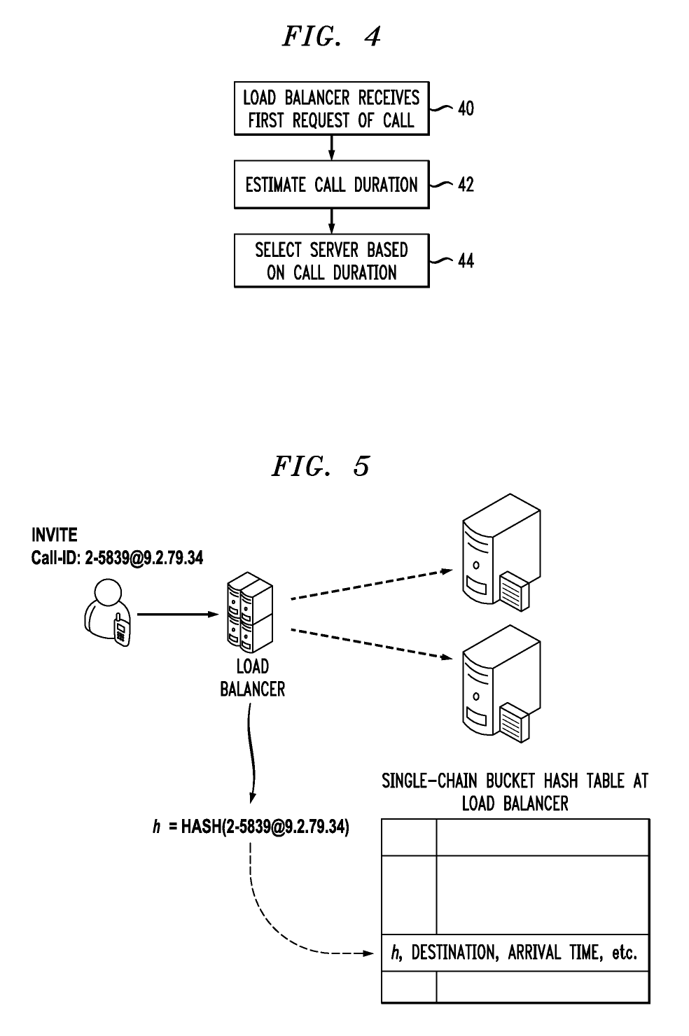

FIG. 4 shows a method for balancing calls among servers in accordance with an embodiment of the invention. In step 40, the load balancer receives a first request corresponding to a call. In the SIP protocol, this would be an INVITE request. In step 42, the load balancer estimates the duration of the call (note that a variation within the spirit and scope of the invention is for the load balancer to obtain the estimate of call duration from another entity—for example, the request could contain an estimate of call length).

There are a number of ways in which call duration could be estimated. For example, call duration could be correlated with the sender, receiver, or sender-receiver pair associated with the call. Some senders might have a tendency to make short calls. Other senders might have a tendency to make long calls. Based on the sender and/or receiver associated with a call, the load balancer could make an estimate of call duration. The system could maintain information on callers and receivers, correlating this information with call duration in the past. Many other methods for estimating call duration are possible within the spirit and scope of the invention.

In step 44, the load balancer selects a server for the request based on call duration. For example, one group of servers g1 may be designated to handle calls with higher overhead. A call expected to be of long duration could be sent to a server in g1. Another group of servers g2 may be designated to handle calls with lower overhead. A call expected to be of short duration could be sent to a server in g2.

We now give other examples of how our load balancer can further use estimates of call length to make better load balancing decisions.

The load balancing algorithms CJSQ, TJSQ, and TLWL (mentioned above) are based on assigning calls to servers by picking the server with the (estimated) least amount of work assigned but not yet completed.

In our system, the load balancer can estimate the work assigned to a server based on the requests it has assigned to the server and the responses it has received from the server. Responses from servers to clients first go through the load balancer which forwards the responses to the appropriate clients. By monitoring these responses, the load balancer can determine when a server has finished processing a request or call and update the estimates it is maintaining for the work assigned to the server.

The Call-Join-Shortest-Queue (CJSQ) algorithm estimates the amount of work a server has left to do based on the number of calls (sessions) assigned to the server. Counters may be maintained by the load balancer indicating the number of calls assigned to a server. When a new INVITE request is received (which corresponds to a new call), the request is assigned to the server with the lowest counter, and the counter for the server is incremented by one. When the load balancer receives an OK response to the BYE corresponding to the call, it knows that the server has finished processing the call and decrements the counter for the server.

It is to be appreciated that the number of calls assigned to a server is not always an accurate measure of the load on a server. There may be long idle periods between the transactions in a call. In addition, different calls may be composed of different numbers of transactions and may consume different amounts of server resources. An advantage of CJSQ is that it can be used in environments in which the load balancer is aware of the calls assigned to servers but does not have an accurate estimate of the transactions assigned to servers.

An alternative method is to estimate server load based on the transactions (requests) assigned to the servers. The Transaction-Join-Shortest-Queue (TJSQ) algorithm estimates the amount of work a server has left to do based on the number of transactions (requests) assigned to the server. Counters are maintained by the load balancer indicating the number of transactions assigned to each server. When a new INVITE request is received (which corresponds to a new call), the request is assigned to the server with the lowest counter, and the counter for the server is incremented by one. When the load balancer receives a request corresponding to an existing call, the request is sent to the server handling the call, and the counter for the server is incremented. When the load balancer receives an OK response for a transaction, it knows that the server has finished processing the transaction and decrements the counter for the server.

It is to be appreciated that, in the TJSQ approach, transactions are weighted equally. There are many situations in which some transactions are more expensive than others, and this should ideally be taken into account in making load balancing decisions. In the SIP protocol, INVITE requests consume more overhead than BYE requests.

The Transaction-Least-Work-Left (TLWL) algorithm addresses this issue by assigning different weights to different transactions depending on their expected overhead. It is similar to TJSQ with the enhancement that transactions are weighted by overhead; in the special case that all transactions have the same expected overhead, TLWL and TJSQ are the same. Counters are maintained by the load balancer indicating the weighted number of transactions assigned to each server. New calls are assigned to the server with the lowest counter. Our SIP implementation of TLWL achieves near optimal performance with a weight of one for BYE transactions and about 1.75 for INVITE transactions. This weight can be varied within the spirit and scope of the invention. Different systems may have different optimal values for the weight. FIG. 8 presents a simple example of how TLWL can be used to balance load (via a load balancer configured in accordance with principles of the invention) in a system with two servers (S1 and S2). In practice, it scales well to a much larger number of servers.

The presentation of the load balancing algorithms so far assumes that the servers have similar processing capacities. In some situations, the servers may have different processing capabilities. Some servers may be more powerful than others. One server might have all of its resources available for handling SIP requests from the load balancer, while another server might only have a fraction of its resources available for such requests. In these situations, the load balancer should assign a new call to the server with the lowest value of estimated work left to do (as determined by the counters) divided by the capacity of the server; this applies to CJSQ, TJSQ, and TLWL.

A simpler form of TJSQ could be deployed for applications in which SARA is not needed. For example, consider a Web-based system communicating over HTTP. The load balancer would have the flexibility to assign requests to servers without regard for sessions. It would maintain information about the number of requests assigned to each server. The key support that the load balancer would need from the server would be a notification of when a request has completed. In systems for which all responses from the server first go back to the load balancer which then forwards the responses to the client, a response from the server would serve as the desired notification, so no further support from the server would be needed.

This system could further be adapted to a version of TLWL without SARA if the load balancer is a content-aware layer 7 switch. In this case, the load balancer has the ability to examine the request and also receives responses from the server; no additional server support would be required for the load balancer to keep track of the number of requests assigned to each server. Based on the contents of the request, the load balancer could assign relative weights to the requests. For example, a request for a dynamic page requiring invocation of a server program could be assigned a higher weight than a request for a file. The load balancer could use its knowledge of the application to assign different weights to different requests.

TLWL can be adapted to take call duration into account in the following manner. TLWL maintains counters which estimate the amount of work assigned to each back-end server. Call-Length-Aware-Transaction-Least-Work-Left (CLA-TLWL) uses estimates of call length to calculate better estimates of load assigned to a server. When an INVITE request corresponding to a new call c1 is received, CLA-TLWL assigns the request to a server s1 using techniques previously described for TLWL. CLA-TLWL differs in the manner in which the counter for s1 is incremented based on the fact that c1 is now assigned to s1. The amount that the counter for s1 is incremented is correlated with the estimated length of the call. For calls with a long estimated duration, the counter for s1 is incremented by a larger amount. For calls with a short estimated duration, the counter for s1 is incremented by a smaller amount.

For requests which are not the first request of a call, CLA-TLWL treats them in a similar fashion as TLWL (described above).

When the load balancer receives an OK response to the BYE corresponding to the call, it knows that the server has finished processing the call and might adjust the counter for the server to take into account the fact that the call has finished executing on the server.

We now describe another load balancing algorithm. This method is to make load balancing decisions based on server response times. The Response-time Weighted Moving Average (RWMA) algorithm assigns calls to the server with the lowest weighted moving average response time of the last n (20 in our illustrative implementation) response time samples. The formula for computing the RWMA linearly weights the measurements so that the load balancer is responsive to dynamically changing loads, but does not overreact if the most recent response time measurement is highly anomalous. The most recent sample has a weight of n, the second most recent a weight of n−1, and the oldest a weight of one. The load balancer determines the response time for a request based on the time when the request is forwarded to the server and the time the load balancer receives a 200 OK reply from the server for the request.

We have also implemented a couple of simple load balancing algorithms which do not require the load balancer to estimate server load, response times, or work remaining to be done.

The hash algorithm is a static approach for assigning calls to servers based on Call-ID which is a string contained in the header of a SIP message identifying the call to which the message belongs. A new INVITE transaction with Call-ID x is assigned to server (Hash(x) mod N), where Hash(x) is a hash function and N is the number of servers. We have used both a hash function provided by OpenSer and FNV hash. OpenSer refers to the open SIP express router (http://www.openser.org) and FNV hash refers to Landon Curt Noll, Fowler/noll/vo (fnv) (http://isthe.com/chongo/tech/comp/fnv/).

The hash algorithm is not guaranteed to assign the same number of calls to each server. The Round Robin (RR) algorithm guarantees a more equal distribution of calls to servers. If the previous call was assigned to server M, the next call is assigned to server (M+1) mod N, where N is again the number of servers in the cluster.

To summarize the previous discussion, we have proposed several session-aware request assignment (SARA) algorithms including but not limited to:
Hash. Given a Call-ID x, the node assigned is (Hash(x) mod N), where N is the number of nodes. Note this algorithm is completely static.
Round Robin (RR). This algorithm tracks where the last session assignment was made. Given that the previous assignment was made to node M, the next session is assigned to node (M+1) mod N, where N is again the number of nodes in the cluster.
Response-time Weighted Moving Average (RWMA). This algorithm tracks the average response time for each back-end node and allocates sessions to the node with the smallest estimate of response time.
Call-Join-Shortest-Queue (CSJQ). This algorithm tracks call assignment to each node by tracking requests. When a new INVITE arrives, the request is assigned to the node with the fewest calls. The counter for that node is increased by one, and is decremented only when the OK response to the BYE is seen.
Transaction-Join-Shortest-Queue (TSJQ). This algorithm tracks transaction assignment to each node. When a new INVITE arrives, the request is assigned to the node with the fewest transactions. Transaction counts are incremented when the request arrives (INVITE, BYE) and decremented when that transaction completes (the appropriate OK for that transaction is seen). Transactions are assumed to have the same weight, except for ACK, which has no weight.
Transaction-Least-Work-Left (TLWL). This algorithm is similar to TJSQ above, except that rather than each transaction having the same weight, INVITE transactions have a higher weight than BYE transactions. In one preferred embodiment, an invite request has a weight of around 1.75 BYE transactions; the weight can be varied within the spirit and scope of the invention. When a new INVITE arrives, the session is assigned to a node with a lowest total sum of weights corresponding to requests assigned but not completed by the node. A variant of this algorithm could assign INVITE transactions a weight of 2 BYE transactions, rather than 1.75. Yet another variant of this algorithm could assign INVITE transactions a weight of 1.5 BYE transactions. Here we distinguish the weights for INVITE and BYE since we observe that the INVITE request poses more work to the server than the BYE.

We also described how TLWL can be adapted to take length of calls into account in estimating load for back-end servers, resulting in CLA-TLWL. It would be straightforward for one skilled in the art to use a similar method for taking call length into account for other algorithms on this list, and thus such modifications would be within the spirit and scope of the invention.

Below is the pseudocode for a main loop of a load balancer:

```
h = hash call-id
look up session in active table
if not found
        /* don't know this session */}
        if INVITE
              /* new session */
              select one node d using algorithm
              (TLWL, TJSQ, RR, Hash, etc)
              add entry (s,d,ts) to active table
              s = STATUS_INV
              node_counter[d] += w_inv
        /* non-invites omitted for clarity */
else /* this is an existing session */
        if 200 response for INVITE
              s = STATUS_INV_200
              record response time for INVITE
              node_counter[d] −= w_inv
        else if ACK request
              s = STATUS_ACK
        else if BYE request
              s = STATUS_BYE
              node_counter[d] += w_bye
        else if 200 response for BYE
              s = STATUS_BYE_200
              record response time for BYE
              node_counter[d] −= w_bye
              move entry to expired table
/* end session lookup check */
if request (INVITE, BYE etc.)
        forward to d
else if response (200/100/180/481)
        forward to client
```

The pseudocode is intended to convey the general approach of the load balancer; it omits certain corner cases and error handling (for example, for duplicate packets). The essential approach is to identify SIP packets by their Call-ID and use that as a hash key for table lookup in a chained bucket hash table, as illustrated in FIGS. 5-7. Two hash tables are maintained: an active table that maintains active sessions and transactions, and an expired table which is used for routing stray duplicate packets for requests that have already completed. This is analogous to the handling of old duplicate packets in TCP when the protocol state machine is in the TIME-WAIT state. When sessions are completed, their state is moved into the expired hash table. Expired sessions eventually time out and are garbage collected. Below is the pseudocode for a garbage collector:

```
T_1 threshold|
ts0: current time|
for(each entry) in expired hash table
        if ts0 − ts > T_1
                remove the entry
```

Our load balancer selects the appropriate server to handle the first request of a call. It also maintains mappings between calls and servers using two hash tables which are indexed by call ID. The active hash table maintains call information on calls the system is currently handling. After the load balancer receives a 200 status message from a server in response to a BYE message from a client, the load balancer moves the call information from the active hash table to the expired hash table so that the call information is around long enough for the client to receive the 200 status message that the BYE request has been processed by the server. Information in the expired hash table is periodically reclaimed by garbage collection. Both hash tables store multiple entities which hash to the same bucket in a linked list.

The hash table information for a call identifies which server is handling requests for the call. That way, when a new transaction corresponding to the call is received, it will be routed to the correct server.

Part of the state of the SIP machine is effectively maintained using a status variable; this helps identify retransmissions. When a new INVITE request arrives, a new node is assigned, depending on the algorithm used. BYE and ACK requests are sent to the same machine where the original INVITE was assigned to. For algorithms that use response time, the response time of the individual INVITE and BYE requests are recorded when they are completed. An array of node counter values is kept that tracks occupancy of INVITE and BYE requests, according to weight; the weight values are described in the particular algorithm below.

We found that the choice of hash function affects the efficiency of the load balancer. The hash function used by OpenSER did not do a very good job of distributing call IDs across hash buckets. Given a sample test with 300,000 calls, OpenSER's hash function only spread the calls to about 88,000 distinct buckets. This resulted in a high percentage of buckets containing several call ID records; searching these buckets adds overhead.

We experimented with several different hash functions and found FNV hash (Landon Curt Noll, “Fowler/Noll/Vo (FNV) Hash”) to be a preferred one. For that same test of 300,000 calls, FNV Hash mapped these calls to about 228,000 distinct buckets. The average length of searches was thus reduced by a factor of almost three.

To reiterate, as described above, FIGS. 5-7 show how session affinity can be maintained using a hash table in accordance with an embodiment of the present invention.

As depicted in FIG. 5, the load balancer will keep call state for the entire duration of the call. That is, the load balancer builds a data structure (such as a hash table, as illustrated) to record the routes of calls when receiving the first request of a call and making a routing decision based on a specific dispatch algorithm. Dictionary lookups in the data structure could be based on the call-id, the caller or the receiver of the call.

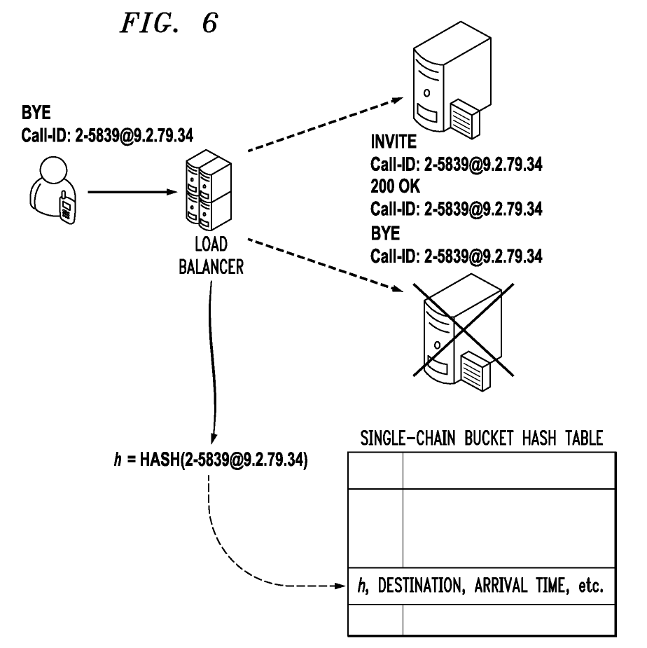

As depicted in FIG. 6, upon receiving subsequent requests corresponding to the call, the load balancer looks up the route in the data structure and then sends the request to the destination node accordingly.

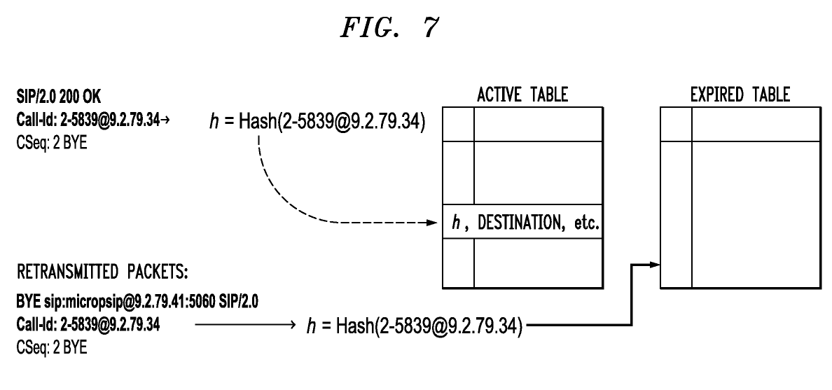

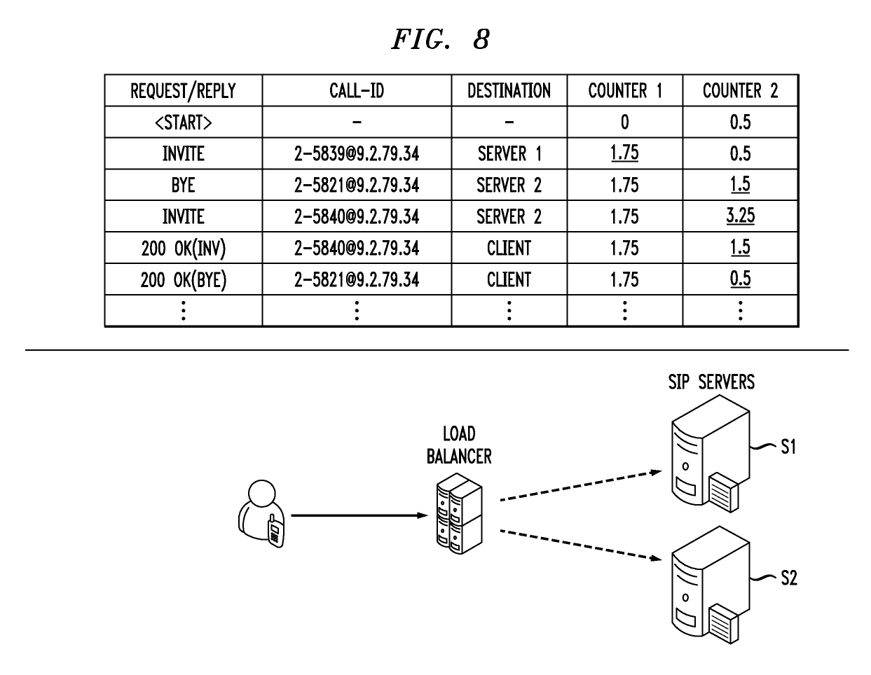

When a call is terminated, the corresponding entry in the active data structure (active table) should be removed to an expired data structure (expired table). This is illustrated in FIG. 7.

To reiterate, as described above, FIG. 8 presents a simple example of how TLWL can be used to balance load (via a load balancer configured in accordance with principles of the invention) in a system with two back-end nodes (servers S1 and S2). The example, inter alia, depicts the content of the counters maintained by the load balancer.

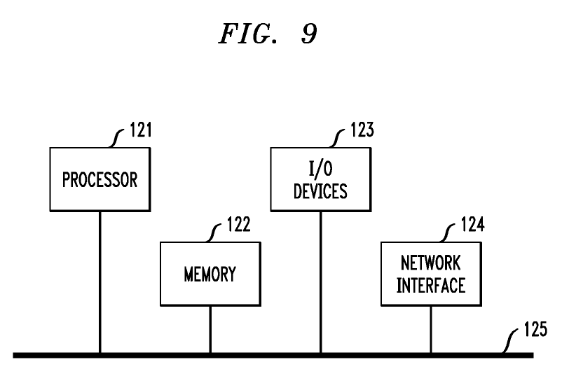

Lastly, FIG. 9 illustrates a computer system in accordance with which one or more components/steps of the techniques of the invention may be implemented. It is to be further understood that the individual components/steps may be implemented on one such computer system or on more than one such computer system. In the case of an implementation on a distributed computing system, the individual computer systems and/or devices may be connected via a suitable network, e.g., the Internet or World Wide Web. However, the system may be realized via private or local networks. In any case, the invention is not limited to any particular network.

Thus, the computer system shown in FIG. 9 may represent one or more load balancers, one or more client devices, one or more servers, or one or more other processing devices capable of providing all or portions of the functions described herein.

The computer system may generally include a processor 121, memory 122, input/output (I/O) devices 123, and network interface 124, coupled via a computer bus 125 or alternate connection arrangement.

It is to be appreciated that the term “processor” as used herein is intended to include any processing device, such as, for example, one that includes a CPU and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard disk drive), a removable memory device (e.g., diskette), flash memory, etc. The memory may be considered a computer readable storage medium.

In addition, the phrase “input/output devices” or “I/O devices” as used herein is intended to include, for example, one or more input devices (e.g., keyboard, mouse, etc.) for entering data to the processing unit, and/or one or more output devices (e.g., display, etc.) for presenting results associated with the processing unit.

Still further, the phrase “network interface” as used herein is intended to include, for example, one or more transceivers to permit the computer system to communicate with another computer system via an appropriate communications protocol.

Accordingly, software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

In any case, it is to be appreciated that the techniques of the invention, described herein and shown in the appended figures, may be implemented in various forms of hardware, software, or combinations thereof, e.g., one or more operatively programmed general purpose digital computers with associated memory, implementation-specific integrated circuit(s), functional circuitry, etc. Given the techniques of the invention provided herein, one of ordinary skill in the art will be able to contemplate other implementations of the techniques of the invention.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. In a system comprised of a network routing calls between at least one caller and at least one receiver wherein the network comprises a load balancer sending requests to a plurality of servers, a method for directing requests associated with calls to said servers, the method comprising steps of:
receiving a first request of a call; and
selecting a server s1 to receive the request based on an estimated duration of the call.

2. The method of claim 1, further comprising a step of sending subsequent requests associated with said call to server s1.

3. The method of claim 1, further comprising a step of estimating a duration of said call.

4. The method of claim 1, wherein the requests correspond to the Session Initiation Protocol (SIP).

5. An article of manufacture for directing requests associated with calls to servers in a system comprised of a network routing calls between at least one caller and at least one receiver wherein the network comprises a load balancer sending requests associated with calls to a plurality of servers, the article comprising a computer readable storage medium including one or more programs which when executed by a computer system perform the steps of claim 1.

6. Apparatus for directing requests associated with calls to servers in a system comprised of a network routing calls between at least one caller and at least one receiver wherein the network comprises a load balancer sending requests associated with calls to a plurality of servers, the apparatus comprising a memory and a processor coupled to the memory and configured to perform the steps of claim 1.

7. In a system comprised of a network routing calls between at least one caller and at least one receiver wherein the network comprises a load balancer sending requests to a plurality of servers, a method for directing requests associated with calls to said servers, the method comprising steps of:
maintaining information regarding load assigned to a plurality of servers;
receiving a first request of a call;
selecting a server s1 to receive the request based on said maintained information;
sending the request to server s1; and
updating said information regarding load based on an estimated length of said call.

8. The method of claim 7, wherein the step of updating said information regarding load assesses a higher value for load assigned to s1 for longer calls.

9. The method of claim 7, further comprising a step of, in response to receiving a notification from server s1 that said request has completed, updating said information regarding load.

10. The method of claim 7, wherein said step of updating said information regarding load is further based on an overhead associated with the request.

11. The method of claim 7, wherein said step of selecting a server s1 to receive the request comprises selecting a server with a least load assigned to it.

12. The method of claim 7, wherein the requests correspond to the Session Initiation Protocol (SIP).

13. An article of manufacture for directing request associated with calls to servers in a system comprised of a network routing calls between at least one caller and at least one receiver wherein the network comprises a load balancer sending requests associated with calls to a plurality of servers, the article comprising a computer readable storage medium including one or more programs which when executed by a computer system perform the steps of claim 7.

14. Apparatus for directing request associated with calls to servers in a system comprised of a network routing calls between at least one caller and at least one receiver wherein the network comprises a load balancer sending requests associated with calls to a plurality of servers, the apparatus comprising a memory and a processor coupled to the memory and configured to perform the steps of claim 7.
